(19) United States
(12) Patent Application Publication
(10) Pub. No.: US 2008/0079224 A1
(43) Pub. Date: Apr. 3, 2008

(54) SEAL OF AN ELECTRICAL CONTROL UNIT OF A HYDRAULIC MACHINE

(75) Inventors: REINHARDT THOMS, Neumunster (DE); ANDERS BJURHAGEN, VIRESTAD (SE)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., AMES, IA (US)

(21) Appl. No.: 11/859,827

(22) Filed: Sep. 24, 2007

(30) Foreign Application Priority Data
Sep. 29, 2006 (DE) 10 2006 046 488.5

(51) Int. Cl. F16J 3/02

(52) U.S. Cl. 277/634

(57) ABSTRACT

Elastically deformable seal of an electrical control unit of a hydraulic machine. The seal has a pot-like shape with a diaphragm, which is in the form of a pot base, and also pot inner faces, pot edge faces and pot outer faces. In this case, the pot inner faces have first sealing faces, the pot edge faces have abutment faces and the pot outer faces have second sealing faces. The first sealing faces and the abutment faces are formed in such a way that they deform under pressure loading such that the second sealing faces arch out from the pot outer faces.

### BACKGROUND OF THE INVENTION

The present invention relates to a seal of an electrical control unit of a hydraulic machine and to the use of the seal in an electrical control unit of a hydraulic machine which is operated with the electrical control unit.

Connectors and plugs are required to make the connections between electronic devices and the associated cable connections. The plugs are usually constituent parts of the cable connections. The connectors are usually integrated in the housing structure of control units. In this case, the housing structure often has to be matched to the customary cable connections by means of its corresponding connectors.

In addition, the choice of connection system depends on the class of protection to be achieved, with sealing of electronic systems often being performed by a separate seal which, for example, is inserted into a housing opening in which the plug is also inserted.

Seals of this type, which are usually annular, surround an inserted plug and provide sealing with respect to the housing by means of their outer faces, are known to a person skilled in the art. These seals prevent moisture or dirt from the outside being able to enter the housing directly via the outer circumference of the plug.

However, one disadvantage of the seals from the prior art is that moisture can enter the plug along the cable sheath. The moisture which enters the plug in this way can then pass further into the interior of the housing, for example of a control unit, via the connectors/contact pins.

The prior art also discloses that electronic assemblies are encapsulated in a housing for accommodation purposes. The encapsulation compositions used in the process have the function of damping vibrations and enveloping the components such that moisture, dirt or aggressive gasses are not able to reach the electrical components. The disadvantage of the encapsulation compositions is that, when there is a change in temperature, internal stresses occur on account of different coefficients of expansion of the electrical components and the encapsulation compositions, and the electrical components may therefore be damaged.

### SUMMARY OF THE INVENTION

The object of the present invention is to provide a way of sealing off a plug region of a housing of an electrical control unit of a hydraulic machine such that the disadvantages known from the prior art are avoided.

The object is achieved by means of a seal according to the features of Claim 1.

Further advantageous refinements of the seal according to Claim 1 can be found in Subclaims 2 to 7.

Claim 8 is directed at an advantageous use of the seal according to the invention in a control unit of a hydraulic machine. Subclaims 9 to 17 are directed at an advantageous refinement of the electrical control unit having a seal according to the invention.

Claim 18 combines the advantages of the control unit according to one of Claims 8 to 17 in a hydraulic machine. Subclaim 19 is directed at an advantageous refinement of the hydraulic machine according to Claim 18.

A housing of an electrical control unit usually has one or more pot-like openings for making contact with a plug. A seal according to the invention can be inserted into these pot-like openings, with the seal according to the invention likewise having a pot-like shape. A diaphragm which has openings and/or predetermined breaking points forms the pot base here. In this case, the diaphragm serves to provide sealing with respect to the contact pins of the electrical components.

The pot wall is formed by pot inner faces, pot edge faces and pot outer faces, with the pot inner faces having first sealing faces, the pot edge faces having abutment faces and the pot outer faces having second sealing faces. In this case, the first sealing faces serve to provide sealing with respect to circumferential faces of a plug which can be inserted into the pot-like opening, and the pot outer faces serve to provide sealing with respect to a circumferential face of the pot-like opening.

Overall, the seal prevents both moisture and dirt from being able to enter the interior of a control unit of a hydraulic machine via the plug circumference or through the interior of the plug via the contact pins.

The openings and/or predetermined breaking points of the diaphragm are ideally provided such that when the contact pins protrude through the diaphragm, the diaphragm is prestressed in these regions. In order to boost the sealing effect, the diaphragm can have an increased material thickness, for example around the openings and/or predetermined breaking points. Profiling the diaphragm in this way increases the prestress force within the diaphragm and improves the sealing effect, with other types of profiling also being possible. A printed circuit board which is located in the interior of a control unit in a housing is elastically accommodated in the housing, expediently with an encapsulation composition, in order to be fixed. In order for the printed circuit board to be able to be connected to a plug by means of its contact pins outside the housing of the electrical control unit, the contact pins have to protrude through apertures in the housing. These housing apertures are usually designed to be larger than the cross section of the contact pins for ease of mounting of the printed circuit board in the housing. In order to ensure that, during encapsulation, no encapsulation composition runs into the pot-like openings, into which a plug is intended to be inserted, the diaphragm of the seal according to the invention prevents the encapsulation composition from passing through the housing apertures.

The diaphragm therefore firstly has the function of preventing moisture from entering the electrical control unit via the contact pins, and secondly has the function of holding back the encapsulation composition during encapsulation of the electrical assemblies in the housing.

By virtue of the encapsulation of the electrical assemblies, in particular of the contact pins, an adhesive connection to the encapsulation means is made at least by the housing, the contact pins or the printed circuit board. An adhesive connection of this type further increases the sealing ability between an exterior and an interior of the electrical control unit.

Therefore, the use of the seal according to the invention has the effect that the electrical control unit, which is provided with the seal according to the invention, satisfies the highest classes of protection. If a plug for making electrical contact with the control unit is inserted into the pot-like opening, the pot inner faces are elastically deformed by the plug circumferential faces in such a way that the sealing faces, which are arranged on the pot inner faces, provide sealing on the plug circumferential faces.

If a seal according to the invention were not inserted into the housing and placed directly on an electrical plug, the result would be that the elastic deformation of the pot inner faces would cause elastic deformation of the pot outer faces too. In this case, the second sealing faces on the pot outer faces would arch outwards, that is to say away from the plug circumferential faces. Since the seal is inserted into the housing before the electrical control unit makes contact with the plug of a cable connection, the elastic deformation of the pot inner faces causes an increase in pressure of the second sealing faces on the circumferential face of the pot-like opening, as a result of which the pressure of the first sealing faces on the plug circumferential faces is increased at the same time. The same applies when the seal according to the invention has been premounted on the plug and is inserted into the housing opening together with the said plug.

In this case, the seal according to the invention is inserted into the pot-like opening in the housing such that an outer side of the diaphragm which is usually arranged asymmetrically within an edge profile is in contact with a base surface of the pot-like opening in the housing, with the edge profile being formed from pot inner faces, pot edge faces and pot outer faces. When a plug is inserted into the pot-like opening for making electrical contact with the electrical control unit, an end face of the plug presses on an inner side of the diaphragm, with the diaphragm being elastically deformed and its outer side being pressed against the base surface.

In order to ensure that the seal according to the invention is mounted at the intended location within the pot-like opening, a latching hook which is arranged on the plug, for example, may be provided, the said latching hook engaging into a corresponding free space in the pot-like opening only when the diaphragm of the seal is elastically compressed.

Another way of fixing the seal within the pot-like opening can, for example, be carried out by means of a plug receptacle which is inserted into the pot-like opening after insertion of the seal. In this case, the plug receptacle is ideally of tubular design and with its outer faces matches the inner faces of the pot-like opening, but without necessarily sealing these off. Here, the inner faces of the plug receptacles are designed such that they can accommodate the outer faces of the plug connection or of the plug. In this case, the length of the plug receptacle or plug sleeve is adapted such that the seal which is located in the pot-like opening, with the edge profile and diaphragm, is pushed or pressed into the pot-like opening by abutment faces on the plug sleeve or plug receptacle, which form the negative of the pot edge faces, such that the outer side of the diaphragm comes to rest against the base surface of the pot-like opening. The plug receptacle or plug sleeve can be secured in the housing by latching, welding, adhesive bonding and all other types of connection between two parts, for example.

If a plug is now introduced into the plug receptacle and pushed so far that the end face of the plug elastically deforms the diaphragm, the plug sleeve can, for example, also be secured between the plug and housing by means of a latching device at the same time. In order to increase the sealing effect of the first and second sealing faces with respect to the plug or the circumferential face of the pot-like opening, the plug receptacle presses, for example, the edge profile of the seal into a seal receptacle in the housing which is arranged adjacent to the base surface of the pot-like opening. In this case, the seal or the edge profile is compressed between the housing receptacle and the plug receptacle and an inner circumference of the edge profile of the seal is reduced, and this results in greater elastic deformation of the pot inner faces/of the edge profile when the plug is inserted, and therefore increases the sealing effect of the first and second sealing faces. As described above, the elastic deformation of the pot inner faces exerts pressure on the circumferential faces of the pot-like opening.

The use of a plug sleeve or plug receptacle is advantageous when mounting electronic assemblies, in particular when encapsulating the printed circuit board and the assemblies arranged on the said printed circuit board to the housing, since the plug receptacle holds the seal in its position and thus prevents the encapsulation material from entering the pot-like opening.

As mentioned in the introduction, the electrical components and the encapsulation means have different coefficients of thermal expansion and it is therefore advantageous for only that side of the printed circuit board on which no electronic components are located to come into contact with the encapsulation means.

To this end, a housing seal is provided which separates the individual plug regions from one another on the housing side in such a way that an encapsulation means cannot flow into an adjacent housing-side plug region. Furthermore, the housing seal prevents the encapsulation means from flowing around the printed circuit board and covering the electronic components. The use of a housing seal of this type therefore results in the printed circuit board firstly being firmly held in the housing and secondly being elastically mounted, with electronic components not being damaged on account of different coefficients of thermal expansion between the encapsulation means and the electronic components when the temperature changes. As an alternative to encapsulation, the electronic components on the printed circuit board are protected by thick film coating.

As an independent module, the electrical control unit may have, for example, two housing parts which accommodate the individual components. Such a module of an electrical control unit can, for example, be attached to a hydraulic machine and be connected to the hydraulic machine by the cable connections which usually end in plugs.

However, the electrical control unit can be designed together with the hydraulic machine such that, for example, a hollow space which is formed on the drive unit of the hydraulic machine forms the second housing part of the electrical control unit. Therefore, the electrical control unit can, for example, be provided only with a housing half-shell and the hydraulic machine has the mating housing piece to this, in order to form a closed housing. An arrangement of this type provides a very compact design of a hydraulic machine having a control unit.

### BRIEF DESCRIPTION OF THE DRAWINGS

The seal according to the invention and its use in an electrical control unit for a hydraulic machine will be explained in greater detail in the text which follows by way of example with reference to figures, in which:

FIG. 1 shows a plan view of the seal according to the invention;

FIG. 2 shows a section through the seal according to the invention along line A-A from FIG. 1;

FIG. 3 shows a front view of an electrical control unit having a seal according to the invention;

FIG. 4 shows a section through the electrical control unit from FIG. 3 along line B-B;

FIGS. 5 and 6 each show a magnification of a detail Z from FIG. 4;

FIG. 7 shows a perspective view of a housing lower part of the electrical control unit; and

FIG. 8 shows a perspective view of a hydraulic machine having an electrical unit in which a seal according to the invention is used.

### DETAILED DESCRIPTION OF THE PREFERRED EMBODIMENTS

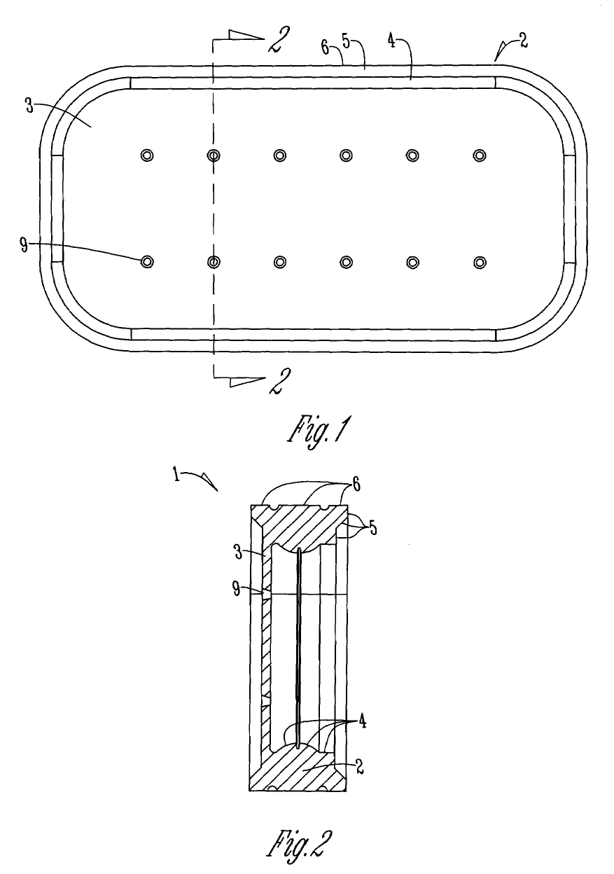

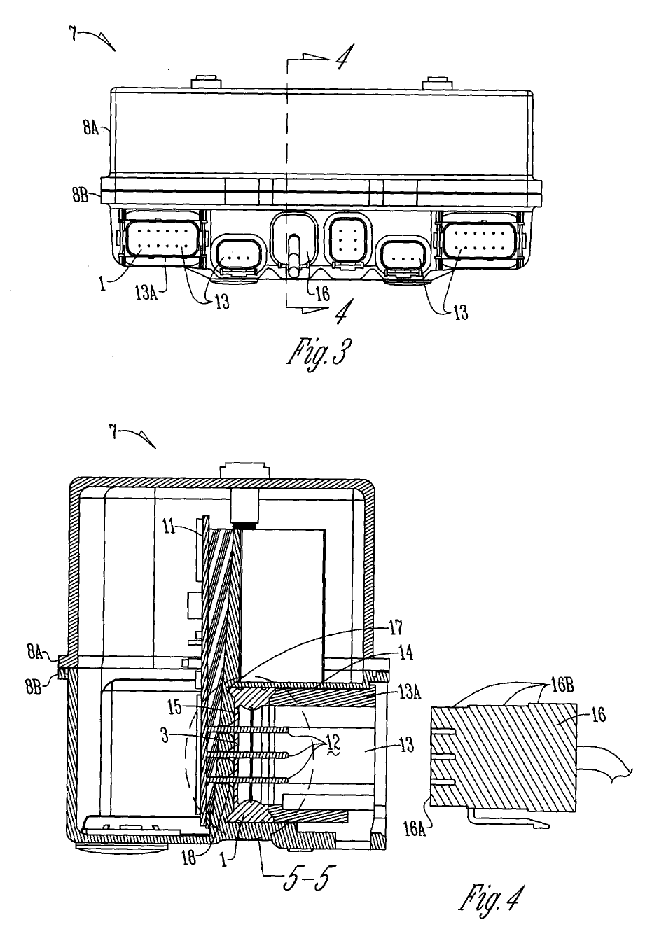

FIG. 1 shows a seal 1 with an edge profile 2 which surrounds a diaphragm 3. As can be seen in FIG. 2 from the section along line A-A from FIG. 1, the seal 1 has a pot-like shape. In this case, the pot base is formed by a diaphragm 3 and the edge profile 2 is formed by pot inner faces 4, pot edge faces 5 and pot outer faces 6. In order to allow contact pins 12 to pass through the seal 1, the seal 1 has openings 9 which, in other embodiments, can also be closed, and has predetermined breaking points 9 at those points at which the contact pins 12 should pass through.

As shown in FIG. 2, the pot inner faces 4 are arched towards the pot interior and are elastically deformed when a cylindrical or cuboidal plug 16, whose plug circumferential faces 16b are substantially perpendicular to the diaphragm, is inserted. On account of the elastic deformation of the pot inner faces 4 together with the first sealing faces 4a, which are arranged on the said pot inner faces, the pot outer faces 6 together with the second sealing faces 6a, which are arranged on the said pot outer faces, arch outwards. However, if the seal is used in a pot-like opening 13 in a housing 8, no arching can occur and pressure is exerted on at least one inner circumferential face 14 of the pot-like opening 13. In other words, the insertion of a plug 16 into a seal 1 without the presence of an outer surrounding receptacle increases the outer circumference of the seal 1. This can be utilized when the seal is inserted into a corresponding receptacle to provide sealing with respect to the receptacle.

For example, the seal 1 in an electrical control unit 7, as is illustrated in FIG. 3, can be inserted into a pot-like opening 13. The control unit illustrated in FIG. 3 has a housing upper part 8a and a housing lower part 8b which together form a housing 8 of the electrical control unit 7. FIG. 3 also shows, by way of example, that the pot-like openings 13 are formed in the housing lower part 8b and plug receptacles 13a are inserted into the pot-like openings 13.

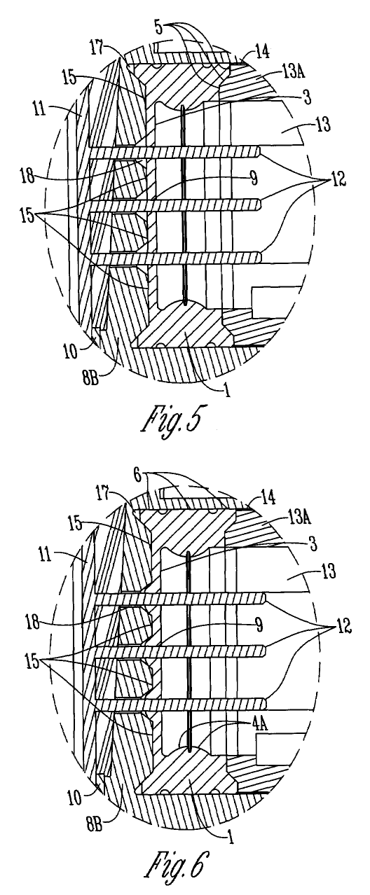

A plug 16 for electrical connection to, for example, a hydraulic machine is inserted into the middle plug receptacle 13a. The arrangement of the electronic components, in particular a printed circuit board 11, is illustrated in FIG. 4 which shows a section along line B-B from FIG. 3. The printed circuit board 11 together with the electronic components located on the said printed circuit board are arranged substantially parallel to a base surface 15 of the pot-like opening 13. In this case, the contact pins 12 which are formed on the printed circuit board 11 protrude in a substantially parallel manner through housing apertures 18 and into the pot-like opening 13. In the mounted position, the seal 1 is arranged in such a way that the diaphragm 3 touches the base surface 15. At least one inner circumferential face 14 of the pot-like opening 13 is designed specifically such that the pot outer faces 6 just touch the at least one inner circumferential face 14 of the pot-like opening 13. The position of the seal 1 is fixed in the direction of the contact pins 12 by a plug receptacle 13a. FIG. 4 illustrates a plug 16 which has not yet been inserted into the plug receptacle 13a and whose outer circumferential faces 16b are substantially parallel to the inner circumferential face 14. If the plug 16 is inserted into the plug receptacle 13a such that the end faces 16a of the plug 16 elastically deform the diaphragm 3, the seal 1 or its edge profile 2 is also elastically deformed, as a result of which the first sealing faces 4a provide sealing with respect to the plug outer faces 1Gb and the second sealing faces 6b provide sealing with respect to the inner circumferential face 14.

FIG. 4 also shows that the plug receptacle 13a, in its end position, pushes the seal 1 or the edge profile 2 so far in the direction of the printed circuit board 11 that the edge profile is clamped between a seal receptacle 17 and the plug receptacle 13a.

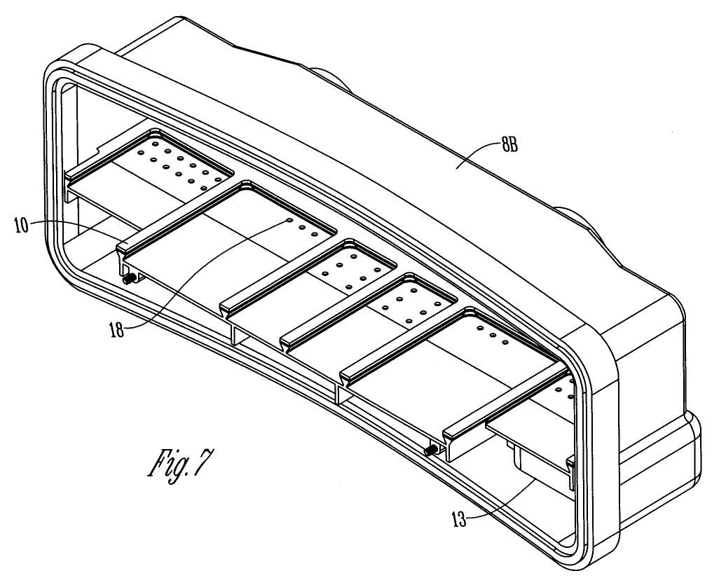

As can further be seen from FIG. 5, the end faces of the plug receptacle 13a are perpendicular to the inner circumferential face 14, rest against the edge profile 2 and are a negative image of the abutment faces 5a and pot edge faces 5 which are formed at the seal 1. In this case, the corresponding faces of the plug receptacles 13a, like the faces of the seal which point in the direction of the seal receptacle 17, are formed in such a way that the edge profile 2 is deformed under pressure of the plug receptacle 13a in the direction of the printed circuit board 11 such that the first sealing faces 4a which are arranged on the pot inner faces 4 are arched over to a more pronounced extent in the direction of the pot interior. This increased overarching can later, when a plug 16 is inserted, increase the sealing force of the seal 1 both with respect to the plug 16 and also with respect to the pot-like opening 13 or the inner circumferential face 14.

FIG. 6 illustrates a further exemplary embodiment of the seal 1 according to the invention. In this case, the seal 1 has a material reinforcement for better sealing off of the contact pins 12 at those points at which the contact pins 12 protrude through the diaphragm.

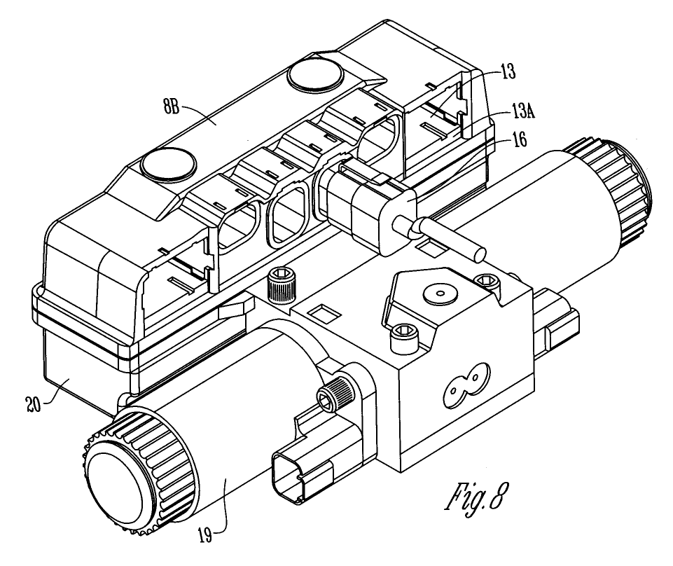

The lower housing part 8b which is illustrated in FIG. 7 has, on its lower face, pot-like openings 13 which have housing apertures 18 in the direction of the housing inner side. A seal 10 is arranged in the housing lower part 8b in such a way that the individual regions which are provided for various groups of contact pins are separated. In this case, each contact pin group forms the mating piece for contact bushings of a plug 16 which can be inserted into the housing lower part at a later time.

The housing seal 10 serves to ensure that no encapsulation means runs into the regions between the individual contact pin groups and the printed circuit board 11 rests elastically on this housing seal 10 during encapsulation, for example of the printed circuit board 11. The edge regions of the housing seal 10 serve to ensure that no encapsulation means flows around the printed circuit board 11 (not illustrated) and comes into contact with the electronic components which are mounted on that side of the printed circuit board 11 which is opposite the contact pin groups or faces away from the housing apertures 18. FIG. 7 illustrates the housing seal 10 in a comb-like manner, with the result that encapsulation material chambers are formed for each plug region when the printed circuit board 11 is borne. The intermediate webs of the housing seal 10 are not required given suitable design of the housing or given suitable accommodation of the printed circuit board 11.

If, as illustrated in FIG. 7, a lower housing part 8b according to FIG. 4 is fitted with components, in particular with the seal 1 according to the invention, with the electronic components and with the plug receptacle 13a, without a housing upper part 8a being placed on the housing lower part 8b, and instead the electrical control unit 7 without a housing upper part, that is to say only with a housing lower part 8b, is placed onto a hollow space of a housing 20 of a drive control unit in such a way that the two elements, the hollow space and the housing lower part 8b, form a closed hollow space, a highly compact construction of a hydraulic machine is achieved, as is illustrated in FIG. 8. However, as has already been described in great detail above, the control unit 7 can also be fitted to a hydraulic machine as an individual module, that is to say with a housing upper part Ba and a housing lower part 8b.

1. Elastically deformable seal (1) of an electrical control unit (7) of a hydraulic machine, which seal (1) has a pot-like shape with a diaphragm (3) which is in the form of a pot base, pot inner faces (4), pot edge faces (5) and pot outer faces (6), with the pot inner faces (4) having first sealing faces (4a), the pot edge faces (5) having abutment faces (5a) and the pot outer faces (6) having second sealing faces (6a), and the first sealing faces (4a) and the abutment faces (5a) being formed in such a way that they deform under pressure loading such that the second sealing faces (Ga) arch out from the pot outer faces (6).

2. Seal (1) according to claim 1, characterized in that the pot inner faces (4), the pot edge faces (5) and the pot outer faces (6) form an edge profile (2) which surrounds the diaphragm (3).

3. Seal (1) according to claim 2, characterized in that at least one expansion of the edge profile (2) perpendicular to the circumferential direction is greater than the wall thickness of the diaphragm (3).

4. Seal (1) according to claim 2, characterized in that the diaphragm (3) is arranged eccentrically with reference to the greatest expansion of the edge profile (2) in the direction of the diaphragm thickness.

5. Seal (1) according to claim 1, characterized in that the diaphragm (3) forms a closed face.

6. Seal (1) according to claim 1, characterized in that the diaphragm (3) has at least one opening (9).

7. Seal (1) according to claim 1, characterized in that the diaphragm (3) is profiled and/or has predetermined breaking points (9).

8. Electrical control unit (7) of a hydraulic machine, with the electrical control unit (7) having:
a housing (8), which has a housing upper part (Ba) and a housing lower part (8b), with at least one printed circuit board (11) which is accommodated in the said housing and is fitted with contact pins (12),
at least one pot-like opening (13) which is formed in the housing lower part (8b), is open towards the outside at the top, and is bounded by at least one inner circumferential face (14) and at least one base surface (15), and
a seal (1) according to claim 1 which can be inserted into the pot-like opening (13), with the pot-like opening (13) being formed in such a way that when the seal (1) is inserted, the diaphragm (3) touches the at least one base surface (15), and the contact pins (12) are arranged in such a way that they protrude through the at least one base surface (15) and through the diaphragm (3) and into the pot-like opening (13) and are substantially parallel to the at least one inner circumferential face (14)

9. Electrical control unit (7) according to claim 8, characterized in that a tubular plug receptacle (13a) can be inserted into the pot-like opening (13) in such way that one end of the plug receptacle (13a) comes to rest against the abutment faces (5) of the seal (1)

10. Electrical control unit (7) according to claim 9, characterized in that the one end of the plug receptacle (13a) presses on the abutment faces (5) of the seal (1) in such a way that the seal (1) is elastically deformed between the plug receptacle (13a) and a seal receptacle (17), which is adjacent to the base surface (15), in such a way that the third sealing faces (6a) press against the at least one inner circumferential face (14) of the pot-like opening (13) and provide sealing with respect to this inner circumferential face.

11. Electrical control unit (7) according to claim 8, characterized in that the printed circuit board (11) is elastically held in the housing (8) by an encapsulation means.

12. Electrical control unit (7) according to claim 11, characterized in that the encapsulation means is adhesively connected at least to the housing (8), to the contact pins (12) or to the printed circuit board (11).

13. Electrical control unit (7) according to Claim 8, characterized in that a plug (16) can be inserted into the seal (1) such that outer plug circumferential faces (16b) press on the first sealing faces (4a) of the seal (1) such that the edge profile (2) of the seal elastically deforms in such a way that the first sealing faces (4a) provide sealing with respect to the plug circumferential faces (16b), and the second sealing faces (6a) press against the at least one inner circumferential face (14) of the pot-like opening (13) and provide sealing with respect to this inner circumferential face.

14. Electrical control unit (7) according to claim 13, characterized in that, in the inserted state, the plug (16) has an end face (17) which is substantially parallel to the base surface (15), elastically deforms the diaphragm (3) of the seal (1) and presses against the base surface (15) of the pot-like opening (13), with the diaphragm (3) providing sealing with respect to the base surface (15).

15. Electrical control unit (7) according to claim 8, characterized in that the diaphragm (3) seals off the contact pins (12) when the seal (1) is inserted into the pot-like opening (13).

16. Electrical control unit (7) according to claim 8, characterized in that the diaphragm (3) seals off the contact pins (12) when the seal (1) is inserted into the pot-like opening (13) and when the plug receptacle (13a) is inserted.

17. Electrical control unit (7) according to claim 8, characterized in that the housing lower part (8b) has a plurality of pot-like openings (13) for accommodating seals (1) according to claim 1, with apertures (18) for receiving contact pins (12) being provided in the base surfaces (15) of the pot-like openings (13), and a housing seal (10) being provided on housing faces opposite the base surfaces (15), which housing seal separates the apertures (18) in the base surfaces (15), which belong to a pot-like opening (13), from apertures in the base surfaces (15), which belong to another pot-like opening (13), on the housing side and serve to support the printed circuit board (11).

18. Hydraulic machine comprising an electrical control unit (7) according to claim 8, characterized in that the hydraulic machine has a further housing (20) of a drive control unit (19) with actuators for controlling the operating parameters of the hydraulic machine, and the electrical control unit (7), in the form of a module, is arranged on the housing (20) of the drive control unit (19).

19. Hydraulic machine according to claim 18, characterized in that the housing (20) of the drive control unit (19) and the housing lower part (B) of the electrical control unit (7) are formed in such a way that together they form a hollow space (21) which is closed towards the outside and in which at least the printed circuit board (11) is accommodated.
